(19) United States
(12) Patent Application Publication
(10) Pub. No.: US 2026/0131774 A1
(43) Pub. Date: May 14, 2026

(54) BRAKE CYLINDER FOR A VEHICLE BRAKE

(71) Applicant: SAF-HOLLAND GmbH, Bessenbach (DE)

(72) Inventors: Rolf Spielmann, Wertheim-Bettingen (DE); Michael Hertwig, Eschau (DE)

(21) Appl. No.: 19/099,239

(22) PCT Filed: Jul. 14, 2023
(86) PCT No.: PCT/EP2023/069709

§ 371 Date: Jan. 5, 2026

(30) Foreign Application Priority Data
Jul. 29, 2022 (DE) 10 2022 119 113.3

(51) Int. Cl. B60T 13/58; B60T 13/36; B60T 13/38; F16D 65/16; F16D 121/08; F16D 121/10; F16D 127/02

(52) U.S. Cl. CPC B60T 13/588; B60T 13/36; B60T 13/38; F16D 65/16; F16D 2121/08; F16D 2121/10; F16D 2127/02

(57) ABSTRACT

A brake cylinder for a vehicle brake includes a spring device having at least a first section for generating a braking force and/or a restoring force for releasing a brake in a stroke direction and having a basic extension extending essentially on a first section plane, a normal of the first section plane being aligned parallel to the stroke direction and/or deviating from the stroke direction by a maximum of 10°, the first section having first subsections and second subsections along the basic extension, the first subsections spaced apart from the first section plane in the positive stroke direction in the unloaded state and the second subsections spaced from the first section plane in the negative stroke direction in the unloaded state, wherein the first and second subsections are at a smaller distance from the first section plane in the loaded state than in the unloaded state.

The invention relates to a brake cylinder for a vehicle brake, in particular for a commercial vehicle brake, and to a vehicle brake with a brake cylinder.

The installation space of vehicle axles, in particular commercial vehicle axles and/or trailer axles, is generally limited. In addition, it can be advantageous to design the spring center of the axle, i.e. in particular the distance between the attachment points of the axle to the wheel suspensions via control arms or springs, as large as possible. This makes it possible, for example, to achieve better tipping stability and/or a larger steering angle in vehicles with steering axles. In addition, the steering angle can be directly dependent on the spring center, as adjacent components, e.g. control arms, brakes, may move towards each other during steering.

At this point, it would be advantageous to reduce the size of the component in order to save costs, material and/or installation space. The component length of brake cylinders, in particular diaphragm or double diaphragm cylinders, is generally determined or influenced by their round wire springs and their spring travel.

It is therefore the object of the invention to provide a brake cylinder in which the required installation space is reduced and/or can be reduced.

This object is solved by a brake cylinder according to claim 1, a vehicle brake according to claim 9 and a use according to claim 10. Further advantages, features and advantageous embodiments of the invention are apparent from the dependent claims, the description and the figures and their description.

According to the invention, a brake cylinder is provided for a vehicle brake, in particular a commercial vehicle brake, comprising a spring device, wherein the spring device is in particular a wave spring. Preferably, the spring device is designed to generate a braking force and/or a restoring force for releasing a brake in a stroke direction of the brake cylinder. Conveniently, the spring device surrounds a piston rod of the brake cylinder. This saves installation space in particular. While round wire springs are usually used in the state of the art to generate a braking force or restoring force, it has been shown that a wave spring can shorten the brake actuation travel or the cylinder stroke used to generate the braking force, because the wave spring requires a shorter spring path and thus less space overall to be able to generate a corresponding force. In particular, the wave spring can also be referred to as a wave ring spring. The wave spring can, for example, comprise corrugated rings made of sheet metal and/or flat wire. In the unloaded state, the corrugated rings can comprise wave bellies or wave maxima and wave minima, whereby the wave bellies are designed in particular to generate a spring force in a compressed state. The spring force can preferably be generated in a displacement direction or stroke direction, this direction can in particular be parallel to the direction in which the piston rod or a piston rod of the brake cylinder extends. Several corrugated rings can be arranged one behind the other in the stroke direction or displacement direction, with the corrugations running in particular circumferentially around the displacement direction or stroke direction and/or perpendicular to the displacement direction or stroke direction. Expediently, in particular in order to achieve a large spring travel, the wave crests of a corrugated ring of the spring device each contact wave troughs of the or an adjacent wave ring, which (fundamentally) can also be referred to as a corrugated ring. A commercial vehicle within the meaning of the invention is in particular a vehicle which has a permissible total weight of more than 3.5 t, preferably more than 7.5 t, particularly preferably more than 15 t, and particularly strongly preferably more than 18 t. The commercial vehicle is in particular a roadworthy and or a road-bound vehicle. Advantageously, the commercial vehicle is a trailer, in particular a semitrailer. The brake cylinder can preferably be an air-actuated, in particular compressed-air-actuated brake cylinder, and/or capable of being air-actuated, in particular compressed-air-actuated. For example, the brake cylinder can be designed to be operated by compressed air as a service brake when used as part of a vehicle brake. Additionally, or alternatively, the brake cylinder can be designed to be activated as a parking brake by means of a spring force of the spring device when used as part of a vehicle brake. In other words, the spring device can be a functional part of a parking brake. The vehicle brake or brake cylinder can, for example, be a diaphragm brake or brake cylinder or a double diaphragm brake or brake cylinder. Additionally, or alternatively, the vehicle brake can be a disk brake, a floating caliper brake and/or a drum brake, for example. In the case of drum brakes, installation space restrictions can also extend to the adjacent chassis, for example, whereby the brake cylinder according to the invention can be particularly advantageous due to its space-saving properties. The brake cylinder can be designed so that the braking force can be counteracted by means of compressed air, for example acting on a diaphragm of the diaphragm brake, so that the braking force caused by the spring device can be canceled out. In other words, the brake cylinder can be designed to put the spring device into a loaded state, in particular by means of compressed air, in which no braking effect is caused by the spring device. It may be provided that the spring device is kept permanently in a loaded state during a journey by means of compressed air in order to generate no braking force. Additionally, or alternatively, the brake cylinder can be designed to generate the braking force in the unloaded state. The spring device can be designed to transmit the braking force to a brake mechanism, e.g. to a brake piston. The brake mechanism can be part of the brake cylinder, in whole or in part. In particular, the braking force of the spring device can be generated via a spring force of the spring device.

A brake cylinder for a vehicle brake, in particular a commercial vehicle brake, is preferably provided, comprising a or the spring device, wherein the spring device for generating a braking force and/or a restoring force for releasing a brake in a stroke direction of the brake cylinder has at least a first section, wherein the first section has a basic extension extending essentially on a first section plane, wherein a normal of the first section plane is aligned essentially parallel to the stroke direction and/or deviates by a maximum of 10° from the stroke direction, wherein the first section has, along its basic extension, in particular alternately, first subsections and second subsections, wherein the first subsections are aligned essentially parallel to the stroke direction and/or deviate from the stroke direction by a maximum of 10°, in particular alternately, first subsections and second subsections, wherein the first subsections are spaced apart from the first section plane in the positive stroke direction in the unloaded state, and wherein the second subsections are spaced apart from the first section plane in the negative stroke direction in the unloaded state, wherein the first and second subsections are designed to be at a smaller distance from the first section plane in the loaded state with the generation of a spring force than in the unloaded state. The brake cylinder is particularly preferably provided for a commercial vehicle brake or for a vehicle brake of a commercial vehicle. The spring device is in particular the spring device already described above. The spring force can correspond to the braking force. Advantageously, with a parking brake operated by spring force, there is no risk of the braking force decreasing in the event of a pressure drop while the vehicle is parked. The braking force of the spring device can be generated in particular via a spring force of the spring device. The braking force acts in particular in the stroke direction, especially in the positive stroke direction. Alternatively, or additionally, the spring device can be designed to release a brake. For example, it may be provided that a braking force, in particular of a service brake is generated by compressed air or another mechanism, and the spring device has the task of generating a restoring force to release the brake. In particular, the restoring force can be designed to retract a push rod, which can also be referred to or designed as a piston rod, or a brake piston when the brake is not impacted by compressed air. The stroke direction can preferably be the direction in which the brake mechanism is actuated, in particular the direction in which a brake piston is moved when the brake is triggered and/or locked. A direction that is radial to the stroke direction is referred to as the radial direction in the context of the present invention. A direction running in a circle around the stroke direction or a displacement axis, in particular the central axis, of the brake cylinder and/or perpendicular to the stroke direction and the radial direction is referred to as the circumferential direction. In particular, it may be provided that the brake mechanism can be moved in the positive stroke direction to trigger and/or lock the brake and can be moved in the negative stroke direction to release the brake. The first section plane (or, analogously, one or more further section planes) can be defined in particular by the fact that in the unloaded state, the first subsections and the second subsections are each approximately equidistant from the first section plane. The distance of the first and second subsections from the section plane can refer to a maximum distance and/or to an average distance. “Approximately” can mean a deviation tolerance of a maximum of 15%, preferably a maximum of 10% and particularly preferably a maximum of 5%, of the total distance. It may be provided that the average distance of the first and second subsections in the normal direction of the section plane adds up to approximately zero. The normal direction corresponds to the direction of the normal of the section plane. The normal direction of the section plane can be tilted slightly relative to the stroke direction, in particular by up to 10°, preferably by up to 5°. This can advantageously allow freedom in the design of the spring device, whereby the braking force may not be affected or only slightly affected. Preferably, the first sections and the second sections have a smaller distance to the first section plane in the loaded state than in the unloaded state. A smaller distance in the sense of the invention can also mean that there is no longer any distance. In other words, the brake cylinder can be designed in such a way that the first and second sub-sections have no or only a slight distance from the first section plane in the loaded state. A slight distance can be a distance which is less than 50%, preferably less than 20%, particularly preferably less than 10%, and particularly strongly preferred less than 5%, of the distance in the unloaded state. The brake cylinder and/or the spring device can be designed in such a way that a spring force is generated by reducing the distance of the first and second sub-sections from the section plane, the spring force being and/or generating in particular the braking force and/or restoring force. The basic extension does not necessarily have to run in a straight line. In particular, the basic extension can have a curved shape, for example. The basic extension can correspond to an optionally curved longitudinal extension of the first section. The arrangement of the first and second subsections can be provided in a periodically varying manner. The first and second sub-sections can follow one another along the basic extension, in particular alternately. As already explained, the spring device can in particular be a wave ring spring or a wave spring. It has been shown that the brake cylinder according to the invention can save installation space. This can be made possible by the fact that the spring device according to the invention can cause a shortening of the brake actuation travel or the cylinder stroke used to generate the braking force, because the spring device according to the invention requires less space than a round wire spring typically used in the state of the art. Advantageously, this can also reduce the length of the brake cylinder. In particular, a reduction in the extension of the component length in the stroke direction of up to 50% can be achieved in comparison with conventional round wire springs. If necessary, this value can be improved even further, for example in brakes with several installed spring devices. It has been found that the stroke or spring travel used according to the state of the art or required by the brake cylinder used is often greater than is necessary for the actual braking process on the part of the brake. The component shortening of the brake cylinder can result in a significant design advantage for the more efficient design or configuration of vehicles, particularly in the area of the vehicle axles. In addition, the brake cylinder according to the invention can have a reduced weight. In particular, the weight of the unsprung mass of the vehicle can thus be reduced.

According to one embodiment, the brake cylinder can have a fastening device for fastening to a vehicle brake. The fastening device can, for example, be configured to enable a force-fit and/or a form-fit and/or a material-fit fastening. The fastening device can, for example, comprise a bayonet lock and/or a clamp fastening. Advantageously, the fastening device can facilitate component integration into a brake, e.g. a disc brake. In addition, the fastening device can make it easier to retrofit the brake cylinder into existing brakes or brake systems.

Advantageously, the first section of the spring device, in particular the complete spring device, is arranged circumferentially around a displacement axis, in particular a central axis, of the brake cylinder that is essentially oriented in the stroke direction. In particular, it may be provided that the basic extension of the first section is arranged in the circumferential direction. The ends of the first section seen in the direction of the basic extension can be connected to one another and/or attached to one another. It may be provided that further sections of the spring device, in particular all sections of the spring device, are arranged circumferentially around a displacement axis, in particular a central axis, of the brake cylinder that is oriented essentially in the stroke direction. “Essentially in the direction of stroke” can include a design-related deviation from a parallel alignment and/or a deviation of maximum 15°, preferably 10°, particularly preferably maximum 5°. The spring device can preferably be aligned in a circle around the displacement axis, in particular the center axis. In particular, the center of the circle can lie essentially on the displacement axis. “Essentially” can mean that the center is a maximum of 15%, preferably a maximum of 10%, particularly preferably a maximum of 5%, of the extension of the radius of the spring device away from the center. Advantageously, a circumferential arrangement enables a particularly efficient optimization of the installation space, in particular also perpendicular to the stroke direction or in the radial direction. In addition, a particularly uniform spring force can be generated in the stroke direction across the radial direction.

Expediently, the first section comprises at least one intermediate section which connects one of the first subsections to one of the second subsections, in particular elastically, and which intersects the first section plane. The at least one intermediate section can preferably be arranged between a respective first sub-section and a second sub-section, which are arranged adjacent to one another, in particular in the circumferential direction. Adjacent can mean in particular that no other first or second subsection is arranged between the two adjacent subsections and/or that no other subsection is closer to the first or second subsection than the other of the two adjacent subsections. Advantageously, the at least one intermediate section can be used to generate a particularly efficient elastic spring force by moving the two sub-sections relatively in the direction of travel. The at least one intermediate section can be arranged centrally inside between the first and second sub-sections in the radial direction and/or can be arranged outside the sub-sections in the radial direction. Particularly preferably, the at least one intermediate section can be arranged in the circumferential direction between two sub-sections. In particular, the first section can comprise a plurality of intermediate sections, each of which connects successive first and second subsections in the direction of the basic extension. It is particularly preferable for the basic extension to run in the circumferential direction. In particular, first subsections and second subsections can be provided alternately in the circumferential direction, whereby the first subsections are each connected to the second subsections following in the circumferential direction by the intermediate sections and vice versa. Advantageously, such an arrangement with intermediate sections can make it possible to obtain a particularly flat spring characteristic curve of the spring device. This can be particularly suitable for use in brake cylinders, especially for the parking brake part of the brake cylinder. In addition, the installation space can be reduced particularly efficiently with such an arrangement.

Advantageously, the first section and/or one or more further sections of the spring device are essentially in the form of a corrugated ring or corrugated rings and/or annular discs or annular discs, wherein wave bellies of the corrugated rings and/or annular discs correspond to the first and second subsections, wherein the rings and/or annular discs are arranged in particular in such a way that the center of the rings/annular discs is arranged essentially on a displacement axis, in particular a central axis, of the brake cylinder oriented in the stroke direction. Wave bellies indicate in particular the maxima and minima of the corrugated rings or annular disks. The maxima and minima of the corrugations correspond in particular to the maximum distance of the first and or further section from the first and/or further section plane as viewed in the stroke direction. The course of the waves can preferably be aligned in the direction of the basic extension. In particular, the circular course of the rings or annular disks can essentially correspond to the circumferential direction running around the displacement axis, in particular the central axis. Areas between the wave bellies can correspond in particular to the intermediate sections as described herein. Advantageously, corrugated rings or annular disks can represent a conceptually and/or production-technically particularly simple and, in terms of spring force, efficient way of providing the spring device according to the invention.

Conveniently, the spring device has at least one further section, in particular a plurality of further sections, corresponding to the first section, wherein the first section and the at least one further section are arranged one behind the other in the direction of travel, in particular adjacent to one another. Advantageously, the multiple sections according to the invention can be used to reinforce the overall spring force particularly efficiently in terms of material and installation space requirements. The further sections can each have further section planes corresponding to the first section, whereby the further section planes can preferably be arranged parallel to the first section plane. The further sections can have further first and second subsections corresponding to the first section and optionally further intermediate sections. All advantages and features relating to the first section can be transferred analogously to the further sections.

In an advantageous embodiment, sections adjacent to each other in the stroke direction contact each other and/or are connected to each other. In particular, it may be provided that the first subsections of a section each contact or are connected to the second subsections of the next section as viewed in the direction of stroke. In particular, contact can be understood to mean “touching”. The spring force can be further increased by contacting or connecting.

In an additionally or alternatively preferred embodiment, first and second sub-sections of two neighboring sections arranged between two neighboring section planes lie directly opposite one another in pairs, in particular at the point of greatest distance from their section plane, whereby in particular opposing first and second sub-sections contact one another in the unloaded and loaded state. The contacting first and second sub-sections can in particular be connected to each other, in particular with a material bond. Advantageously, a particularly stable spring device can be made possible with this embodiment.

In an additionally or alternatively preferred embodiment, the sections have, on the section planes, a maximum radial extension in a radial direction perpendicular to the stroke direction, the maximum radial extension of successive sections being variable in the positive or negative stroke direction. Particularly preferably, the maximum radial extension of successive sections is, in the positive or negative stroke direction, monotonic, in particular strictly monotonic, decreasing, whereby the spring device is in particular conical with a cone axis running essentially in the stroke direction. The maximum radial extension is defined in particular by the largest extension of the respective section seen in the radial direction. If the sections are in a form of ring or disk, the maximum radial extension can correspond to the circular diameter of the rings or disks. Viewed in the stroke direction, the end of the spring device with a smaller maximum radial extension can be adjacent to a diaphragm of the diaphragm cylinder. Advantageously, a spring device with a decreasing radial extension can enable improved adaptation to the installation space. In particular, a spring characteristic curve that progressively increases with increasing load can be realized with a conical design.

In an additionally or alternatively preferred embodiment, the sections on the section planes have a maximum radial extension in a radial direction perpendicular to the stroke direction, the maximum radial extension of successive sections being the same in the positive or negative stroke direction, in particular such that the spring device is cylindrical with a cylindrical axis extending substantially in the stroke direction. In particular, the maximum radial extension can be as defined above. With this embodiment, a particularly strong braking effect can be generated if necessary. In particular, a cylindrical design can enable a relatively constant and/or strongly increasing spring characteristic curve.

Advantageously, the brake cylinder comprises two spring devices each as described herein, the spring devices being spaced apart from one another in the stroke direction. It may be provided that components not belonging to the spring devices, e.g. a diaphragm, are arranged between the spring devices. In other words, there may in particular be two separate spring devices. For example, one of the spring devices may be part of a parking brake and the other of the spring devices may be part of a service brake. Advantageously, several types of brakes can thus be combined in a particularly space-saving manner.

In an additionally or alternatively preferred embodiment, the brake cylinder comprises a spring device with variable maximum radial extension as described herein, in particular a conical or cone-shaped spring device, and a cylindrical spring device. The two spring devices can in particular be spaced apart from each other in the stroke direction. Advantageously, a variable spring device that saves installation space or is adapted to the installation space can thus be combined with a cylindrical spring device with particularly strong spring force. This allows particularly good adaptation to the available installation space while simultaneously achieving a high spring force.

In an advantageous embodiment, an extension in the stroke direction of a first of the two spring devices, in particular the conical spring device, is in a ratio of 0.3 to 0.9, preferably 0.5 to 0.8, particularly preferably 0.6 to 0.7, to an extension in the stroke direction of a second of the two spring devices, in particular the cylindrical spring device. Such a ratio has proven to be particularly favorable in terms of saving installation space. A ratio of 0.5 to 0.8 can be particularly favorable in order to achieve a particularly usable spring force of both the conical spring and the cylindrical spring. A ratio of 0.6 to 0.7 can also be a particularly favorable arrangement for the provision of a parking brake and a service brake.

In an advantageous embodiment, neighboring sections merge into one another in a spiral. The normal of the sections can be slightly inclined relative to the stroke direction, in particular inclined by up to 10°, whereby the respective sections can in particular be arranged essentially parallel to one another. The spiral can preferably extend around a displacement axis, in particular the central axis, of the brake cylinder that runs in the stroke direction. A single section can preferably correspond to one revolution of the spiral. A spiral-like design can advantageously achieve an increased spring force, whereby the braking force can be generated particularly efficiently.

The brake cylinder is preferably a diaphragm cylinder or a double diaphragm cylinder. The diaphragm cylinder can preferably have a brake cylinder size of 10 to 30″, preferably 16″ to 24″. The double diaphragm cylinder can preferably have a brake cylinder size of 10″/18″ to 30″/40″, preferably 16″/24″ to 20″/30″. Space optimization is particularly effective with diaphragm cylinders. In particular, a double diaphragm cylinder can benefit in two ways from the optimization of installation space if two spring devices are provided in the double diaphragm cylinder. One of the two spring devices can be used as part of a service brake, for example, while another spring device can be used as a parking brake, for example.

The diaphragm cylinder can have a cylinder housing, whereby the spring device can be arranged in the cylinder housing. The cylinder housing can have a spring area, in which the spring device is arranged, and a compressed air area, which is designed for filling in compressed air. The compressed air area can have a compressed air inlet for filling compressed air. In particular, the compressed air inlet can be aligned in the stroke direction. The spring area and the compressed air area can be separated by a diaphragm, whereby the diaphragm separates the spring area and the compressed air area from each other in an airtight manner, whereby the diaphragm is designed to compress the spring device by loading when compressed air is introduced into the compressed air area, whereby in particular the compressed air area is enlarged by displacement of the diaphragm and the spring area is reduced when compressed air is introduced into the compressed air area. The diaphragm cylinder can comprise a push rod or piston rod for generating a braking force, whereby the push rod, which can also be a piston rod, is connected to the spring device and/or the diaphragm in such a way that the push rod is moved in the stroke direction when the spring device is contracted and extracted. The push rod can be arranged partly in the cylinder housing, in particular in the compressed air area, and partly outside the cylinder housing, whereby the push rod is designed in particular to be moved partly out of the cylinder housing when the spring device is contracted and/or extracted. The diaphragm cylinder can comprise a bellows which surrounds the push rod outside the cylinder housing. A clevis configured to activate a brake may be disposed at the end of the push rod remote from the spring device. The push rod can be aligned essentially along the displacement axis of the diaphragm cylinder. The spring device can contact the diaphragm and/or be attached to the diaphragm with a first end when viewed in the stroke direction and contact the cylinder housing or be attached to the cylinder housing with a second end opposite the first end when viewed in the stroke direction. The diaphragm cylinder can, for example, be designed so that when compressed air is introduced into the compressed air area, the spring device is loaded and compressed by means of the diaphragm, so that the push rod is pushed out of the cylinder housing against the restoring force of the spring device in order to generate a braking force and/or a braking effect, and that when the compressed air is released from the compressed air area, the diaphragm and the push rod are pushed back by the restoring force of the spring device in order to end the braking effect.

The double diaphragm cylinder can have a two-part cylinder housing with a first cylinder housing part and a second cylinder housing part, wherein a first spring device, in particular as described herein, can be arranged in the first cylinder housing part. The first cylinder housing part can have a first spring area, in which the first spring device is arranged, and a first compressed air area, which is designed for filling compressed air. The first compressed air area can have a first compressed air inlet for filling compressed air. In particular, the first compressed air inlet can be aligned in the radial direction. The first spring area and the first compressed air area can be separated by a diaphragm, wherein the diaphragm separates the first spring area and the first compressed air area from one another in an airtight manner, wherein the diaphragm is configured to compress the first spring device by loading when compressed air is introduced into the first compressed air area, wherein in particular the first compressed air area is enlarged by displacement of the diaphragm and the first spring area is reduced when compressed air is introduced into the first compressed air area. The double diaphragm cylinder can comprise a first push rod for generating a braking force, the first push rod being connected to the first spring device and/or the diaphragm in such a way that the first push rod is moved in the stroke direction when the first spring device is contracted and extracted. The first push rod can be arranged partly in the cylinder housing, in particular in the first compressed air area, and partly outside the cylinder housing, the first push rod being designed in particular to be moved partly out of the cylinder housing when the first spring device is contracted and/or extracted. The double diaphragm cylinder can comprise a bellows which surrounds the first push rod outside the cylinder housing. A clevis configured to activate a brake may be disposed at the end of the first push rod remote from the first spring device. The first push rod can be aligned essentially along the displacement axis of the double diaphragm cylinder. Viewed in the stroke direction, the first spring device can contact the diaphragm with a first end and/or be attached to the diaphragm and contact the cylinder housing or be attached to the cylinder housing with a second end opposite the first end viewed in the stroke direction. The double diaphragm cylinder can, for example, be designed so that when compressed air is introduced into the first compressed air area, the first spring device is loaded and compressed by means of the diaphragm, so that the first push rod is pushed out of the cylinder housing against the restoring force of the first spring device in order to generate a braking force and/or a braking effect, and that when the compressed air is released from the compressed air area, the diaphragm and the push rod are pushed back by the restoring force of the spring device in order to end the braking effect. A second spring area and a second compressed air area, which is designed for filling compressed air, can be provided in the second cylinder housing part, with the second compressed air area in particular being arranged between the first cylinder housing part and the second spring area. A second spring device that can be activated in the stroke direction, in particular as described herein, can be provided in the second spring area. The second compressed air area can have a second compressed air inlet for filling compressed air. In particular, the second compressed air inlet can be aligned in the radial direction.

The second spring area and the second compressed air area can be separated from each other in an airtight manner such that the second spring device is compressed by loading when compressed air is introduced into the second compressed air area, so that in particular the second compressed air area increases by displacing and/or reducing the second spring area when compressed air is introduced into the second compressed air area. The double diaphragm cylinder may comprise a second push rod, wherein the second push rod contacts the diaphragm and is configured to be displaced with the second spring area in the stroke direction, so that the second push rod is moved in the stroke direction when the second spring device is contracted and extracted and contracts the first spring device when the second spring device is extracted, so that the one parking brake force is generated by means of the first push rod. The second push rod can be aligned essentially along the displacement axis of the double diaphragm cylinder. The second push rod can be a piston rod. The second spring device may have the features, advantages or embodiments disclosed above and below in relation to the spring device. Seen in the stroke direction, the second spring device can make contact with and/or be attached to one end of the second spring section facing the second compressed air section and make contact with the other end with the cylinder housing or be attached to the cylinder housing. The double diaphragm cylinder can, for example, be designed so that when compressed air is introduced into the second compressed air area, the second spring device is loaded and compressed so that the second push rod is pushed back so that the first spring device is not loaded by the second spring device and that when the compressed air is released from the compressed air area, the second push rod is pushed forward by the spring force of the second spring device so that the first spring device is compressed and the braking effect is generated. Advantageously, the double diaphragm cylinder can be designed to generate a braking force of a service brake and a braking force of a parking brake. In particular, the first spring device can be designed to automatically release a service brake if there is no compressed air in the first compressed air area, whereby the second spring device can be designed to activate a parking brake if there is no compressed air in the second compressed air area.

Advantageously, the spring device is at least partially, in particular completely, made of metal, with the first section of the spring device in particular being made of metal. The spring device can be made of steel, for example. Manufacture from metal can be advantageous for use in brake cylinders, in particular in commercial vehicles. For example, a spring device made of metal can enable increased stability and/or reliability of the spring device.

Conveniently, the spring device is manufactured in sections, in particular at least the first section, from sheet metal, with the other sections in particular also being manufactured from sheet metal. Manufacture from sheet metal can enable a particularly space-saving design of the spring device, especially in the direction of stroke. Advantageously, the ratio of an extension of the sheet metal in the stroke direction to an extension of the first section in the radial direction can be less than 0.3, preferably less than 0.1, particularly preferably less than 0.05, wherein a lower limit of this ratio can in particular be greater than 0.001, preferably greater than 0.005, particularly preferably greater than 0.01. A ratio of less than 0.3 (and preferably greater than 0.001) can enable a particularly space-saving design. A ratio in the range of less than 0.1 (and preferably greater than 0.005) can also make it possible to save weight and material while still maintaining good stability. A ratio of less than 0.05 (and preferably greater than 0.01) can be particularly efficient.

Advantageously, in the unloaded state, a diameter of the spring device in the radial direction is in a ratio of 0.5 to 5, preferably 1 to 3, particularly preferably 1.1 to 2.0 to an extension of the spring device in the stroke direction. Advantageously, this ratio enables a particularly space-saving design. In particular, a ratio of 1 to 3 offers a particularly efficient combination of saved installation space and stability. A ratio of 1.1 to 2.0 can be particularly favorable for commercial vehicle brakes.

The ratio of the diameter of the spring device in the radial direction to the spring travel of the spring device is advantageously 0.5 to 20, preferably 1 to 10, particularly preferably 2 to 8. This allows a particularly good braking force to be achieved.

Advantageously, the spring device comprises 2 to 20, preferably 3 to 10, particularly preferably 6 to 8, sections, wherein the sections are arranged one behind the other, particularly in the direction of stroke, wherein the sections are particularly the first section and the further sections. It has been found that 2 to 20 sections can generate a good braking force. With 3 to 10 sections, a good saving of installation space can also be achieved without falling short of the required braking force. Between 6 and 8 sections can prove to be particularly efficient.

Conveniently, the first section comprises 2 to 20, preferably 3 to 10, particularly preferably 4 to 8, first subsections and/or 2 to 20, preferably 3 to 10, particularly preferably 4 to 8, second subsections. The further sections can have a corresponding number of first and/or second subsections, in particular a number of subsections lying in the same areas. In a conical embodiment, the number of subsections of the further sections can optionally vary, e.g. become smaller with a smaller diameter of the cone. 2 to 20 sub-sections can be arranged particularly well in a brake cylinder. 3 to 10 sub-sections can provide a particularly good combination of stability and braking force. In this respect, 4 to 8 sub-sections can be particularly advantageous for commercial vehicle brakes.

A further aspect of the invention is a vehicle brake, in particular a commercial vehicle brake, with a brake cylinder as described herein. All advantages and features of the brake cylinder can be transferred analogously to the vehicle brake and vice versa. The vehicle brake can, for example, be a disk brake, a floating caliper brake and/or a drum brake.

A further aspect of the invention is a use of a wave spring, in particular a spring device as described herein, for a commercial vehicle brake. Preferably, the spring device is used to generate a braking force and/or a restoring force for releasing a brake in a stroke direction of the brake cylinder. All advantages and features of the brake cylinder and the vehicle brake can be transferred analogously to the application and vice versa.

Individual features and embodiments mentioned can be combined with each other and the advantages assigned to the individual features also apply to a combination of these features. Further advantages and features of the invention are apparent from the following description of preferred embodiments of the object according to the invention with reference to the accompanying figures. The following description serves only to clarify the invention and should not be understood as limiting the appended claims to one of the embodiments. Individual features disclosed in the embodiments shown may also be used in other embodiments, unless this has been expressly excluded. It shows

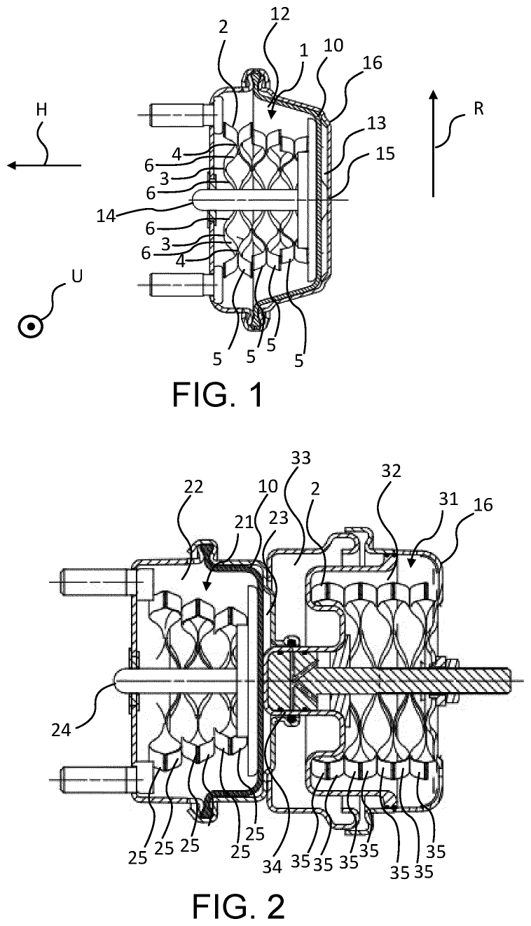

FIG. 1 a sectional view of a brake cylinder according to a first embodiment of the invention,

FIG. 2 a sectional view of a brake cylinder according to a second embodiment of the invention.

FIG. 1 shows a sectional view of a brake cylinder according to a first embodiment of the invention. In this embodiment, the brake cylinder is a diaphragm cylinder. The diaphragm cylinder has a spring device 1 for generating a restoring force for releasing a brake in a stroke direction H of the brake cylinder, the spring device 1 being shown here in the unloaded state. The spring device 1 is arranged circumferentially around a displacement axis of the brake cylinder oriented in the stroke direction H. The spring device 1 has a first section 2 and several further sections 5. The further sections 5 are basically constructed in the same way as the first section 2. The first section 2 has several first subsections 3 and second subsections 4 in the direction of its basic extension, which here runs in the circumferential direction U. The first subsections 3 each correspond to wave bellies of the wave-ring-shaped first section 2, whereby the wave bellies are deflected in the positive stroke direction H and can therefore also be referred to as shaft crests. The second subsections 4 each correspond to wave bellies of the first section 2, which is in the shape of a wave ring, whereby the wave bellies are deflected in the negative stroke direction H. These wave wave bellies can therefore also be referred to as wave troughs. In this example, the first section plane (not shown) corresponds to a plane whose normal runs in the stroke direction H and whose edge runs in the radial direction R in this representation, the first section plane being arranged in the center of the first section 2 as viewed in the stroke direction H, namely exactly in the middle between the first subsections 3 and the second subsections 4. The first subsections 3 and the second subsections 4 are each elastically connected to one another by intermediate sections 6, whereby the intermediate sections 6 intersect the first section plane. Neighboring sections 2, 5 in the stroke direction H contact each other so that first subsections 3 and second subsections 4 of two neighboring sections 2, 5 arranged between two neighboring section planes 2, 5 lie directly opposite each other in pairs at the point of greatest distance from their section plane. Opposite first and second sub-sections 3, 5 touch each other both in the unloaded state and in the loaded state (not shown here). The sections 2, 5 have a maximum radial extension in the radial direction R, whereby the maximum radial extension of successive sections 2, 5 is strictly monotonically decreasing in the negative stroke direction or, in this case, decreasing in a conical shape. In this embodiment example, the diaphragm cylinder also has a cylinder housing 16, which has a spring area 12, in which the spring device 1 is arranged, and a compressed air area 13. When compressed air is introduced into the compressed air area 13 through the compressed air inlet 15, a diaphragm 10 is pushed forward between the compressed air area 13 and the spring area 12 in the stroke direction H, so that the spring device 1 is compressed. This also pushes a push rod 14 forwards, which in turn actuates a brake. If the compressed air is released from the compressed air area 13, the push rod 14 is retracted by the restoring force of the spring device 1 and the brake is released.

FIG. 2 shows a sectional view of a brake cylinder according to a second embodiment of the invention. In this embodiment, the brake cylinder is a double diaphragm cylinder. The double diaphragm cylinder has a first spring device 21 and a second spring device 31. The spring devices 21, 31 are basically constructed in the same way as the spring device 1 shown in FIG. 1. The sections 25 of the first spring device 21 also have a maximum radial extension in the radial direction R, whereby the maximum radial extension of successive sections 25 is, in the negative stroke direction H, strictly monotonically decreasing or, in this case, conically decreasing. The sections 35 of the second spring device 31, on the other hand, have a constant maximum radial extension in the radial direction R, so that the second spring device is cylindrical. The double diaphragm cylinder has a cylinder housing 16, which has a first spring area 22, in which the first spring device 21 is arranged, a second spring area 32, in which the second spring device 31 is arranged, a first compressed air area 23 and a second compressed air area 33. When compressed air is introduced into the first compressed air area 23, a diaphragm 10 is advanced between the first compressed air area 23 and the first spring area 22 in the stroke direction H, so that the spring device 21 is compressed. This also pushes a first push rod 24 forwards, which in turn actuates a brake. If the compressed air is released from the first compressed air area 23, the push rod 24 is retracted by the restoring force of the spring device 21 and the brake is released. The right-hand part of the double diaphragm cylinder, on the other hand, serves as a parking brake. This is not activated if there is compressed air in the compressed air area 33 and the spring device 31 is therefore compressed. If, on the other hand, the spring device is not compressed, it exerts pressure on the diaphragm 10 and thus on the first spring device 21 via the second push rod, whereby the first spring device 21 is compressed, the first push rod 24 is pushed forwards in the stroke direction H and the brake is activated.

### LIST OF REFERENCE SYMBOLS

1—Spring device

2—First section

3—First section

4—second section

5—further section

6—Intermediate section

12—Spring area

13—Compressed air area

14—Push rod

15—Compressed air inlet

16—Cylinder housing

21—first spring device

22—first spring area

23—First compressed air area

24—first push rod

25—Sections of the first spring device

31—second spring device

32—second spring area

33—second compressed air area

34—second push rod

35—Sections of the second spring device

H—Stroke direction

R—Radial direction

U—circumferential direction

Brake cylinder for a vehicle brake, in particular a commercial vehicle brake, comprising a spring device, the spring device (1) having at least a first section (2) for generating a braking force and/or a restoring force for releasing a brake in a stroke direction (H) of the brake cylinder, the first section (2) having a basic extension extending essentially on a first section plane, a normal of the first section plane being aligned essentially parallel to the stroke direction (H) and/or deviating from the stroke direction (H) by a maximum of 10°, wherein the first section (2) has first subsections (3) and second subsections (4) along its basic extension, in particular alternately, wherein the first subsections (3) are spaced apart from the first section plane in the positive stroke direction (H) in the unloaded state, and wherein the second subsections (4) are spaced from the first section plane in the negative stroke direction (H) in the unloaded state, wherein the first and second subsections (3, 4) are designed to be at a smaller distance from the first section plane in the loaded state with the generation of a spring force than in the unloaded state.

1.-15. (canceled)

16. A brake cylinder for a commercial vehicle brake, comprising:
a spring device comprising a wave spring;
wherein the brake cylinder comprises a diaphragm cylinder or a double diaphragm cylinder; and
wherein the spring device is configured to generate a braking force and/or a restoring force for releasing a brake in a stroke direction of the brake cylinder.

17. The brake cylinder according to claim 16, wherein the spring device for generating the braking force and/or a restoring force for releasing the brake in a stroke direction of the brake cylinder has at least a first section;
wherein the first section has a basic extension extending essentially on a first section plane;
wherein a normal of the first section plane is aligned substantially parallel to the stroke direction and/or deviates by a maximum of 10° from the stroke direction;
wherein the first section has first subsections and the subsections along the basic extension;
wherein the first subsections are spaced apart from the first section plane in the positive stroke direction in an unloaded state;
wherein the second subsections are spaced from the first section plane in the negative stroke direction in the unloaded state; and
wherein the first and second subsections are configured to be at a smaller distance from the first section plane in a loaded state with the generation of a spring force than in the unloaded

18. The brake cylinder according to claim 17, wherein the first section comprises at least one intermediate section which elastically connects one of the first subsections to one of the second subsections and which intersects the first section plane, wherein the first section comprises a plurality of intermediate sections which each connect successive first and second subsections in the direction of the basic extension.

19. The brake cylinder according to claim 17, wherein the first section and/or one or more further sections of the spring device comprise corrugated rings and/or annular disks;
wherein wave bellies of the corrugated rings and/or annular disks correspond to the first and second sub-sections;
wherein the rings and/or annular disks are arranged such that a center of the rings/annular disks is arranged on a displacement axis of the brake cylinder oriented in the stroke direction.

20. The brake cylinder according to claim 17, wherein the spring device has a plurality of further sections corresponding to the first section; and
wherein the first section and the at least one further section are arranged one behind the other, adjacent to one another, in the stroke direction.

21. The brake cylinder according to claim 20, wherein adjacent sections in the stroke direction are each in contact with and/or connected to one another.

22. The brake cylinder according to claim 20, wherein first and second sub-sections of two adjacent sections arranged between two adjacent section planes lie directly opposite each other in pairs at the point of greatest distance from their section plane; and
wherein opposite first and second sub-sections contact each other in the unloaded and loaded state.

23. The brake cylinder according to claim 20, wherein the sections have, on the section planes, a maximum radial extension in a radial direction perpendicular to the stroke direction;
wherein the maximum radial extension of successive sections is configured to decrease monotonically in the positive or negative stroke direction; and
wherein the spring device is conical with a cone axis extending substantially in the stroke direction.

24. The brake cylinder according to claim 20, wherein the sections have, on the section planes, a maximum radial extension in a radial direction perpendicular to the stroke direction; and
wherein the maximum radial extension of successive sections is configured to be the same in the positive or negative stroke direction such that the spring device is cylindrical with a cylinder axis extending substantially in the stroke direction.

25. The brake cylinder according to claim 16, wherein the brake cylinder comprises two spring devices each according to claim 16, and wherein the spring devices are spaced apart from each other in the stroke direction.

26. The brake cylinder according to claim 23, wherein the brake cylinder comprises a conical spring device and a cylindrical spring device.

27. The brake cylinder according to claim 16, wherein in the unloaded state a diameter of the spring device in the radial direction is in a ratio of 0.5 to 5 to an extension of the spring device in the stroke direction.

28. The brake cylinder according to claim 27, wherein the ratio is 1 to 3.

29. The brake cylinder according to claim 28, wherein the ratio is 1.1 to 2.

30. A commercial vehicle brake, comprising a brake cylinder according to claim 16.

31. A use of a wave spring in a brake cylinder for a commercial vehicle brake according to claim 16.
